(19) United States
(12) Patent Application Publication
(10) Pub. No.: US 2025/0196853 A1
(43) Pub. Date: Jun. 19, 2025

(54) DYNAMIC CAUSAL GRAPH PREDICTION

(71) Applicant: Honda Motor Co., Ltd., Tokyo (JP)

(72) Inventors: Yi XU, Boston, MA (US); Enna SACHDEVA, Santa Clara, CA (US); Nakul AGARWAL, San Francisco, CA (US); Kwonjoon LEE, San Jose, CA (US); Behzad DARIUSH, San Ramon, CA (US)

(21) Appl. No.: 18/612,146

(22) Filed: Mar. 21, 2024

Related U.S. Application Data
(60) Provisional application No. 63/580,288, filed on Sep. 1, 2023.

(51) Int. Cl. B60W 30/095; G06N 7/01

(52) U.S. Cl. CPC B60W 30/0956; G06N 7/01

(57) ABSTRACT

A system for generating a control action for an ego-vehicle based on an action prediction for each participant within an operating environment is achieved through the generation of a time-varying dynamic causal graph. The system comprises a memory storing one or more instructions and a processor executing one or more stored instructions. The processor is configured to generate the time-varying dynamic causal graph of one or more participants within the operating environment, including the ego-vehicle, one or more agents, and one or more potential obstacles. Additionally, the processor generates the action prediction for each participant within the operating environment based on the dynamic causal graph. Furthermore, the processor generates the control action for the ego-vehicle based on the action prediction for each participant within the operating environment.

### BACKGROUND

In real-world scenarios, agents must collaborate through time-varying interactions to achieve shared goals, making static causal graphs inadequate for long-term predictions. Consider an ego vehicle merging into a busy highway lane, where the ego vehicle and another vehicle at its side in the highway lane simultaneously influence each other. During the merge, a negotiation between the ego vehicle and the vehicle in the highway lane is cyclic until the merge is complete, at which point the relationship becomes acyclic. With this scenario in mind, this disclosure introduces a model employing time-varying causality to predict agents' behavior. Dynamic causal graphs are utilized to predict agents' intentions and trajectories over extended periods, reasoning that causal graphs may not always conform to a directed acyclic graph (DAG). For example, in situations where two vehicles merge into a lane simultaneously, negotiations occur to determine the right-of-way, resulting in mutual influences and cyclic patterns within the causal graph. This type of interaction necessitates modeling the co-influential relationship as a hypernode, requiring joint prediction rather than conditional prediction.

### BRIEF DESCRIPTION

According to one aspect, a system for dynamic causal graph prediction is provided. A memory stores one or more instructions, and a processor executes the one or more of the instructions stored on the memory. The processor is configured to generate a time varying dynamic causal graph of one or more participants within an operating environment including an ego-vehicle, one or more agents, and one or more potential obstacles. The processor generates an action prediction for each participant within the operating environment based on the dynamic causal graph. The processor generates a control action for the ego-vehicle based on the action prediction for each participant within the operating environment.

According to another aspect, a computer-implemented method for dynamic causal graph prediction is provided. The method includes generating a time varying dynamic causal graph of one or more participants within an operating environment including an ego-vehicle, one or more agents, and one or more potential obstacles. The method includes generating an action prediction for each participant within the operating environment based on the dynamic causal graph. Furthermore, the method includes generating a control action for the ego-vehicle based on the action prediction for each participant within the operating environment.

According to yet another aspect, a vehicle is provided including a vehicle sensor system, a vehicle actuator system, and a vehicle electronic control unit. The vehicle electronic control unit is in communication with the vehicle sensor system and the vehicle actuator system. The electronic control unit, in conjunction with a memory storing one or more instructions, is programmed to execute the one or more instructions. Accordingly, the electronic control unit is configured to generate a time varying dynamic causal graph of one or more participants within an operating environment including the vehicle, one or more agents, and one or more potential obstacles based on input from the vehicle sensing system. The electronic control unit generates an action prediction for each participant within the operating environment based on the dynamic causal graph. Furthermore, the electronic control unit generates a control action for the vehicle based on the action prediction for each participant within the operating environment, and the vehicle actuator system controls the vehicle to perform the control action.

### BRIEF DESCRIPTION OF THE DRAWINGS

FIG. 1 is an exemplary component diagram of a system for dynamic causal graph prediction, according to one aspect.

FIG. 2 is an exemplary flow diagram of a computer-implemented method for dynamic causal graph prediction, according to one aspect.

FIG. 3 is an exemplary illustration of a scenario associated with the system for dynamic causal graph prediction of FIG. 1, according to one aspect.

FIGS. 4A-4F are exemplary illustrations of scenarios associated with the system for dynamic causal graph prediction of FIG. 1, according to one aspect.

FIGS. 5A-5B are exemplary illustrations of scenarios associated with the system for dynamic causal graph prediction of FIG. 1, according to one aspect.

FIG. 6 is an illustration of an example computing environment where one or more of the provisions set forth herein are implemented, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein, may be combined, omitted, or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “database”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “mobile device”, as used herein, may be a computing device typically having a display screen with a user input (e.g., touch, keyboard) and a processor for computing. Mobile devices include handheld devices, portable electronic devices, smart phones, laptops, tablets, and e-readers.

A “vehicle”, as used herein, refers to any moving vehicle that is capable of carrying one or more human occupants and is powered by any form of energy. The term “vehicle” includes cars, trucks, vans, minivans, SUVs, motorcycles, scooters, boats, personal watercraft, and aircraft. In some scenarios, a motor vehicle includes one or more engines. Further, the term “vehicle” may refer to an electric vehicle (EV) that is powered entirely or partially by one or more electric motors powered by an electric battery. The EV may include battery electric vehicles (BEV) and plug-in hybrid electric vehicles (PHEV). Additionally, the term “vehicle” may refer to an autonomous vehicle and/or self-driving vehicle powered by any form of energy. The autonomous vehicle may or may not carry one or more human occupants.

A “vehicle system”, as used herein, may be any automatic or manual systems that may be used to enhance the vehicle or ego-vehicle, and/or driving. Exemplary vehicle systems include an autonomous driving system, an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pre-tensioning system, a monitoring system, a passenger detection system, a vehicle suspension system, a vehicle seat configuration system, a vehicle cabin lighting system, an audio system, a sensory system, among others.

An “agent”, as used herein, may be a machine that moves through or manipulates an environment. Exemplary agents may include robots, vehicles, or other self-propelled machines. The agent may be autonomously, semi-autonomously, or manually operated.

A “dynamic causal graph”, as used herein, refers to a graphical model that represents evolving causal relationships and dependencies among variables over time.

A “directed acyclic graph”, as used herein, refers to a graphical representation of a set of variables and their causal relationships without any cycles. It is a directed graph where the edges have a direction representing the causal influence of one variable on another, and there are no closed loops or cycles in the graph.

A “cyclic graph”, as used herein, refers to a graphical representation of a set of variables and their causal relationships containing at least one cycle. A cycle is a path of edges and vertices in a graph where the starting and ending vertices are the same, forming a closed loop. A graph is cyclic if it has a sequence of edges that starts and ends at the same vertex.

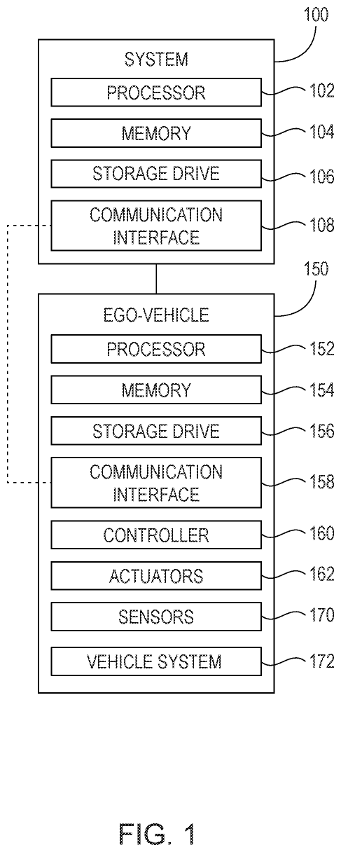

FIG. 1 is an exemplary component diagram of a system 100 for dynamic causal graph prediction, according to one aspect. The system 100 for dynamic causal graph prediction may be implemented on-board a vehicle (e.g., illustrated ego-vehicle 150) or remotely from the autonomous vehicle, such as on a mobile device, for example. The system 100 for dynamic causal graph prediction may include a processor 102, a memory 104, a storage drive 106, and a communication interface 108. The ego-vehicle 150 may include a processor 152, a memory 154, a storage drive 156, a communication interface 158, a controller 160, actuators 162, sensors 170, and one or more vehicle systems 172.

Although described herein primarily using the processor 102, it will be appreciated that any processing, computations, predictions, etc. described herein may be performed by either the processor 102 of the system 100 for dynamic causal graph prediction and communicated to the ego-vehicle 150 via the communication interfaces 108, 158 and/or performed by the processor 152 of the ego-vehicle 150. In this way, the respective components may be communicatively coupled and/or in computer communication with one another.

At a high level, the system 100 for dynamic causal graph prediction may receive information regarding a surrounding environment, generate a dynamic causal graph representative of aspects of the surrounding environment, and make predictions based on the dynamic causal graph. These predictions may be utilized to facilitate a smoother driving or riding experience for occupants of the ego-vehicle 150.

According to one aspect, the system 100 for dynamic causal graph prediction may include the processor 102 and the memory 104. The memory 104 may store one or more instructions. The processor 102 may execute one or more of the instructions stored on the memory 104 to perform one or more acts, actions, or steps.

### Dynamic Causal Graph Generation

The processor 102 may generate a time varying dynamic causal graph of one or more participants within an operating environment including an ego-vehicle 150, one or more agents, and one or more potential obstacles based on data received from sensors 170 on the ego-vehicle 150 and/or information received via the communication interface 158, such as via vehicle-to-vehicle (V2V) communications. In any event, this data may include trajectory, velocity, acceleration information etc. related to each participant (e.g., the ego-vehicle 150, agents, potential obstacles, etc.). Within the dynamic causal graph, one or more of the agents may be another vehicle, a bicycle, or a motorcycle. One or more of the potential obstacles may be another vehicle, a bicycle, a motorcycle, a traffic sign, a pedestrian, an intersection, or a road feature. Thus, agents may be considered potential obstacles as well. One or more nodes of the dynamic causal graph may represent the ego-vehicle 150 or one or more of the agents. In this way, the relationships between participants of a traffic scene may be encoded in a graph.

According to one aspect, one or more edges of the dynamic causal graph may represent a causal relationship (e.g., cause-effect relationship) or a correlative relationship (e.g., mutual influence) between two nodes of the dynamic causal graph.

The causal relationship may be a leader-follower relationship, a trajectory-dependency relationship, or a collision relationship. Explained in greater detail, the processor 102 may define an edge when a first node or agent A (i.e., one or more of the agents or one or more of the potential obstacles) causes a second node or agent B (i.e., one or more of the other agents or one or more of the other potential obstacles) to change motion or trajectory. Stated another way, a future trajectory of agent B may depend on a future trajectory of agent A, and thus, y_{B}=f(y_{A}). Another example of the causal relationship may be the collision relationship, such as when agent B will collide with agent A if agent B does not change trajectory. A probabilistic interpretation of a generated dynamic causal graph which is acyclic may be P_{Y}_{₁}_{,Y}_{₂}_{,Y}_{₃}_{|X}=P_{Y}_{₁}_{|X}P_{Y}_{₂}_{|Y}_{₁}_{,X}P_{Y}_{₃}_{|Y}_{₁}_{,Y}_{₂}_{,X}.

The correlative relationship may be a negotiation relationship. Explained in greater detail, the processor 102 may define an edge when a first node or agent A (i.e., one or more of the agents or one or more of the potential obstacles) and a third node or agent C (i.e., one or more of the other agents or one or more of the other potential obstacles) influence each other's trajectories simultaneously, resulting in a cycle in the dynamic causal graph. In this scenario, agents A and C are treated as a hypernode, using joint prediction instead of conditional prediction. Specifically, the cycle between agent A and agent C is addressed by representing them as a hypernode in the equation P{A,B,C}=P{B}*P{A,C|B}. Additionally, refining this scenario through iterative updates is expressed as P{A,C|B}=P{A|C}*P{C|B}+P{C|A}*P{A|B}.

The dynamic causal graph may not consistently adhere to an acyclic or cyclic structure but could include either or both characteristics at varying points in time. In instances where influencing agents form a cycle (hypernode), joint prediction is used, and conditional prediction is used outside of these cycles.

### Prediction Generation Using Graph-Based Reasoning

The processor 102 may generate a prediction for each participant (e.g., thereby locally modeling each participant) within the operating environment based on the dynamic causal graph. For example, a local model may mean a predictive model for each node or each agent in the dynamic causal graph. The generating the prediction for each participant within the operating environment may be based on a topological sort and/or a cyclic sort of the nodes of the dynamic causal graph. Once the dynamic causal graph is sorted, the dynamic causal graph may be a directed acyclic graph (DAG) at certain time-steps and a cyclic graph at other time-steps, or both DAG characteristics and cyclic graph characteristics may be present simultaneously.

The DAG may have a property such that each node has a smaller index than the node's descendants. Due to this property of the DAG, prediction of each node may be performed sequentially since a node's parent's behaviors may already be predicted. In other words, once local models are obtained for each node, the local models may be combined, and top-down reasoning may be performed to achieve a global inference or global reasoning.

When the dynamic causal graph exhibits cyclic characteristics, indicating mutual influences and interactions among participants in, for example, a traffic scenario, lane change feasibility checks can be used to assess the viability of lane changes or other adjustments in current traffic conditions. The lane change feasibility check assesses participant behavior, such as a probability of deviation and an amount of deceleration. The probability of deviation refers to a likelihood that a participant might deviate from its existing trajectory. The amount of deceleration, or reduction in speed, is assessed as participants adjust speed based on the ongoing cyclic interactions within the dynamic causal graph. In summary, when confronted with cyclical relationships among participants, the system may employ the lane change feasibility check to dynamically assess the probabilities of trajectory deviations and the amount of deceleration within the operating environment. For example, an initial predicted lane change probability may be discounted according to a distance between the agent under prediction and its potential follower after deviation. The closer they are, the more the probability will be discounted.

When the dynamic causal graph includes both acyclic and cyclic characteristics in its structure, the dynamic graph is modeled such that, at certain time steps or locations, it adheres to a DAG structure. In contrast, at other time steps, the dynamic causal graph may exhibit cyclic characteristics where interactions among participants form cycles. During acyclic phases, the prediction of each node can be executed sequentially. However, in cyclic phases, the system adopts joint prediction. In this way, cycles are treated as hyper nodes, allowing for the comprehension and prediction of complex interactions amongst the participants.

The action prediction for each participant may be an intention prediction or a trajectory prediction. The intention prediction may be based on an intelligent driver model (IDM) which is a probabilistic model and may give the intention prediction as an intention to slow down, an intention to deviate lanes or positions with a lane, an intention to accelerate, an intention to decelerate, an intention to stop, an intention to drift left, an intention to drift right, an intention to turn left, an intention to turn right, etc.

According to one aspect, this may be given by P[deviate|scenario]=σ(β(IDM headway−actual headway−default)) or P[deviate|scenario]=σ(β(IDM deceleration−default)). For example, the default values may be empirical thresholds of acceleration or headway that cause the following vehicle to deviate when the thresholds are exceeded.

For trajectory prediction, a deviation trajectory may be calculated based on a planned trajectory, which may be decomposed into a lateral movement and a longitudinal movement, each modeled as a polynomial in time. Additionally, boundary conditions may be applied, such as an amount of lateral deviation, a time to complete deviation, etc. These boundary conditions may be set as tunable parameters for the model and may be specified or learned. In this way, the processor 102 may generate a behavior model for each participant or agent within the operating environment to facilitate latent and chain reaction predictions related to the dynamic causal graph. Stated another way, the processor 102 may monitor participants within the operating environment (including the ego-vehicle 150, one or more agents, and one or more potential obstacles) and identify one or more of the potential obstacles which may cause one or more of the agents to deviate from a current trajectory, thereby impacting the ego-vehicle 150 via a chain reaction.

One advantage of the use of the dynamic causal graphs herein is that a warning generated may also include an explanation of a causal chain or chain reaction (e.g., which may not necessarily be apparent to occupants of the ego-vehicle 150), thereby increasing trust of the occupants or driver with regard to the ego-vehicle 150. A neural network, on the other hand, may be model free, and thus, more difficult to generate an explanation for the occupants. Since the boundary conditions may be set as tunable parameters, this model may be flexible as to a balance between warning frequency and mis-predictions.

Additionally, the processor 102 may estimate whether or not or a likelihood that a collision may occur between the ego-vehicle 150 and one or more of the other agents or between one or more of the other agents and one or more of the potential obstacles. This likelihood of collision may be determined by checking to see if a collision would occur if the ego-vehicle 150 does not change its driving behavior or trajectory and considering the ego-vehicle 150's parent nodes within the dynamic causal graph (e.g., immediate leader's predicted behavior).

### Action Generation

The processor 102 may generate a control action for the ego-vehicle 150 based on the action prediction for each participant within the operating environment. The control action may be a warning to be provided by one or more vehicle systems 172 (e.g., speaker, display, tactile device), a driving maneuver to be implemented by the controller 160, actuators 162, one or more vehicle systems 172 (e.g., which may be an autonomous driving system or a driving assistance system), a communication from a first vehicle to a second vehicle using vehicle-to-vehicle (V2V) communication, etc., or any combination of these. In this way, latent and chain reactions may be foreseen via the dynamic causal graph and predictions and actions may be generated for the ego-vehicle 150 to mitigate collisions which may not necessarily be apparent to occupants of the ego-vehicle 150.

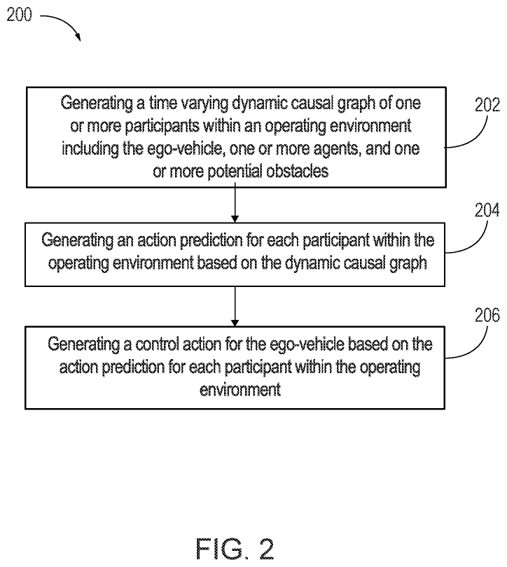

FIG. 2 is an exemplary flow diagram of a computer-implemented method 200 for dynamic causal graph prediction, according to one aspect. For example, the computer-implemented method 200 for dynamic causal graph prediction includes, at 202, generating a time varying dynamic causal graph of one or more participants within an operating environment including the ego-vehicle 150, one or more agents, and one or more potential obstacles. The method 200 further includes, at 204, generating an action prediction for each participant within the operating environment based on the dynamic causal graph and, at 206, generating a control action for the ego-vehicle 150 based on the action prediction for each participant within the operating environment.

One or more of the agents may be another vehicle, a bicycle, or a motorcycle. One or more of the potential obstacles may be another vehicle, a bicycle, a motorcycle, a traffic sign, a pedestrian, an intersection, or a road feature. One or more nodes of the dynamic causal graph may represent the ego-vehicle 150 or one or more of the agents. One or more edges of the dynamic causal graph may represent a causal relationship or a correlative relationship between two nodes of the dynamic causal graph. The causal relationship includes at least one of a leader-follower relationship, a trajectory-dependency relationship, or a collision relationship. The correlative relationship includes at least a negotiation relationship. The action prediction for each participant may be an intention prediction or a trajectory prediction. The generating the action prediction for each participant within the operating environment may be based on a topological sort and/or a cyclic sort of the dynamic causal graph. The control action may be a warning to be provided by one or more of the vehicle systems 172. The control action may be a driving maneuver to be implemented by one or more of the vehicle systems 172.

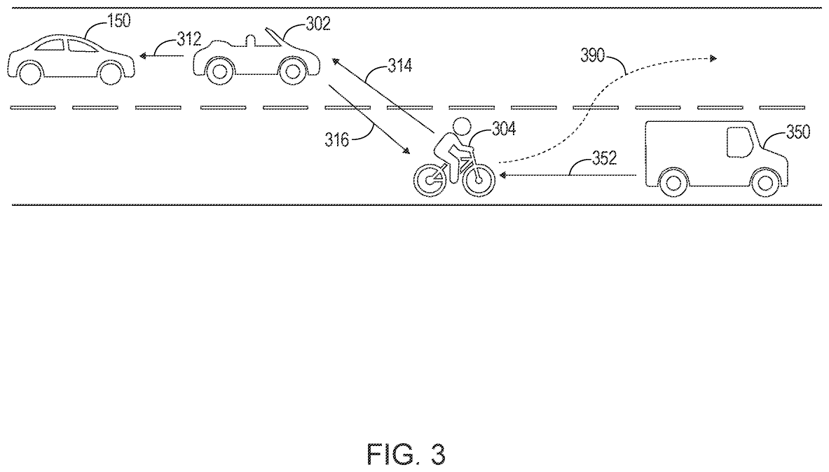

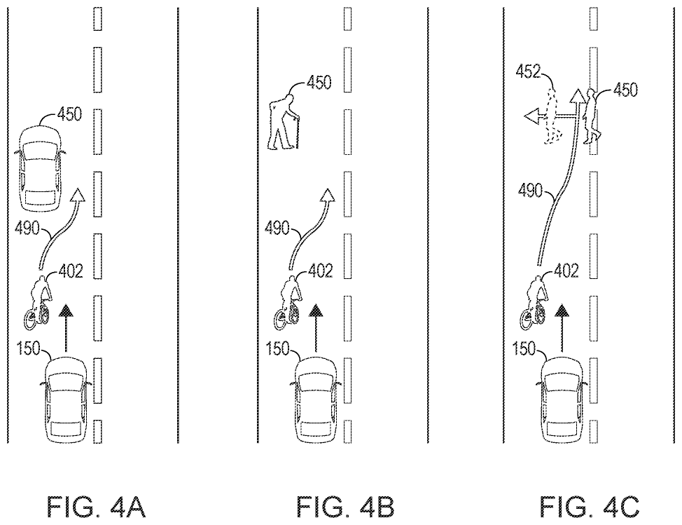

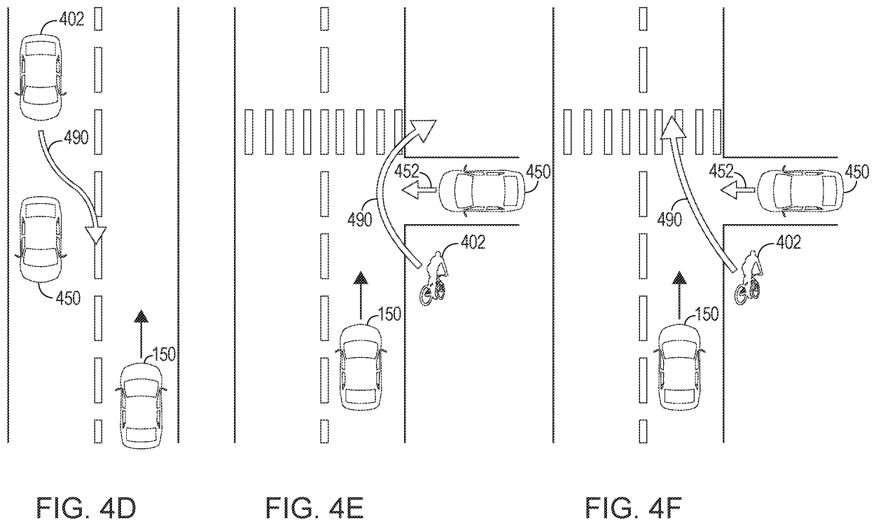

FIG. 3 is an exemplary illustration of a scenario associated with the system 100 for dynamic causal graph prediction of FIG. 1, according to one aspect. FIGS. 4A-4F are exemplary illustrations of scenarios associated with the system 100 for dynamic causal graph prediction of FIG. 1, according to one aspect.

As seen in FIG. 3, the ego-vehicle 150 is behind another vehicle (e.g., agent 302) which is behind a bicycle (e.g., agent 304) which is behind a parked vehicle (e.g., a potential obstacle 350). Note that agents 302, 304 may also be considered as potential obstacles. A dynamic causal graph associated with the traffic scenario of FIG. 3 may have edges 312, 314, 316, 352. Edge 312 may represent agent 302 impact on ego-vehicle 150. Edges 314, 316 may represent the effect that agents 302, 304 have on one another, forming a cyclical relationship. Edge 352 may represent the impact that the parked vehicle or potential obstacle 350 has on the bicycle or agent 304. The potential obstacle 350 may cause the agent 304 to deviate trajectory 390. This deviated trajectory 390 of agent 304 may cause agent 302 to slow, thereby impacting the ego-vehicle 150. Using the dynamic causal graph, predictions, modeling, and action generation described above with reference to the system 100 for dynamic causal graph prediction of FIG. 1 may mitigate collisions for the ego-vehicle 150.

FIGS. 4A-4F illustrate different examples of the ego-vehicle 150 being affected by an agent 402 which may be impacted by a potential obstacle 450. The potential obstacle 450 may be static, stationary, dynamic, or moving along a trajectory 452, or changing, for example. This may be seen in FIG. 4C where the pedestrian is walking. In FIG. 4D, the potential obstacle 450 may be an oncoming vehicle. In FIGS. 4E-4F, the potential obstacle 450 may be another vehicle coming to a stop at an intersection prior to moving again. Due to the potential obstacle 450, the agent 402 may deviate trajectory 490, thereby impacting the ego-vehicle 150.

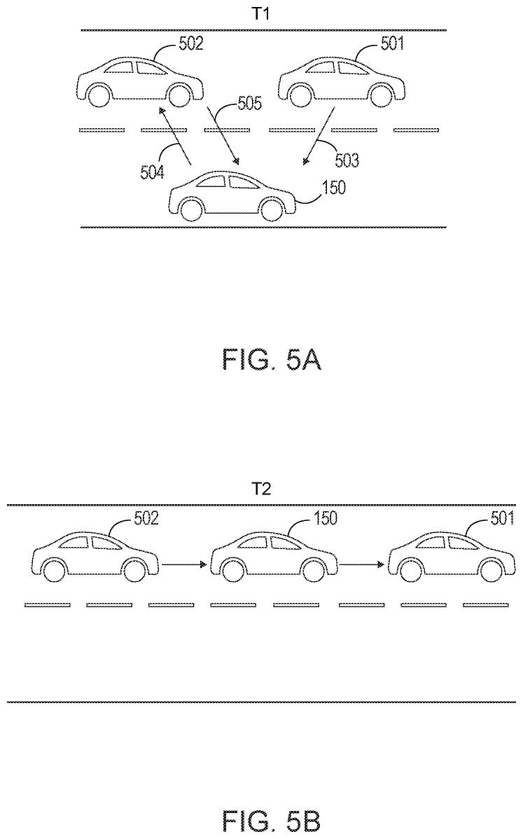

FIGS. 5A-5B illustrate an example of the ego-vehicle 150 being influenced by agents 501 and 502. The ego-vehicle 150 also affects agent 502, creating a cycle at a first time step T1, shown in FIG. 5A. As a result, a correlative relationship exists between the ego-vehicle 150 and agent 502 which is cyclical and is therefore considered a hypernode that utilizes joint prediction. In this scenario, agent 150 (A) and agent 502 (C) are treated as a hypernode, employing joint prediction instead of conditional prediction. Agent 501 (B) exists outside the hypernode. The cycle between agent A and agent C is addressed by representing them as a hypernode in the equation P{A,B,C}=P{B}*P{A,C|B}. Additionally, refining this scenario through iterative updates is expressed as P{A,C|B}=P{A|C}*P{C|B}+P{C|A}*P{A|B}.

At a second time step T2, shown in FIG. 5B, the merging of the ego-vehicle 150 into the lane of agents 501 and 502 is complete, and the relationship between the ego-vehicle 150 and agent 502 transitions to a causal relationship, allowing for conditional prediction.

A dynamic causal graph associated with the traffic scenario depicted in FIGS. 5A and 5B may feature edges 503, 504, 505, 506, and 507. The edge 503 represents the impact of the agent 501 on the ego-vehicle 150. The edges 504 and 505 represent the mutual influence that the ego-vehicle 150 and the agent 502 have on each other, having the cyclical relationship. The edge 506 represents the impact of agent 501 on ego-vehicle 150, while the edge 507 represents the influence of the ego-vehicle 150 on the agent 502. Accordingly, FIGS. 5A and 5B conceptualize a dynamic causal graph evolving over changing timesteps, wherein the relationships amongst the ego-vehicle 150 and the agents 501, 502 can change, influencing the subsequent handling of predictions.

In dynamic traffic scenarios, employing both joint and conditional prediction methods presents a robust mathematical approach. Joint prediction considers relationships among various elements simultaneously, offering a comprehensive understanding of the system. Mathematically, this entails a joint probability distribution. Conditional prediction focuses on forecasting the future state of one variable based on others, facilitating real-time adaptability. Transitioning between joint and conditional prediction at a specified time step, or vice versa, or among specific participants refines predictions for increased precision. This dual strategy maintains a balance between a comprehensive overview and adaptive precision in response to changing traffic dynamics, thereby enhancing safety and collision avoidance capabilities.

The aspects performed by the processor discussed above involve processor-executable instructions configured to implement one aspect of the techniques presented herein. An implementation includes a computer-readable medium, such as a CD-R, DVD-R, flash drive, a platter of a hard disk drive, etc., on which is encoded computer-readable data. This encoded computer-readable data, such as binary data including a plurality of zero's and one's, in turn includes a set of processor-executable computer instructions configured to operate according to one or more of the principles set forth herein. In this implementation, the processor-executable computer instructions may be configured to perform a method, such as the computer-implemented method 200 of FIG. 2. In another aspect, the processor-executable computer instructions may be configured to implement a system, such as the system 100 of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. Byway of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

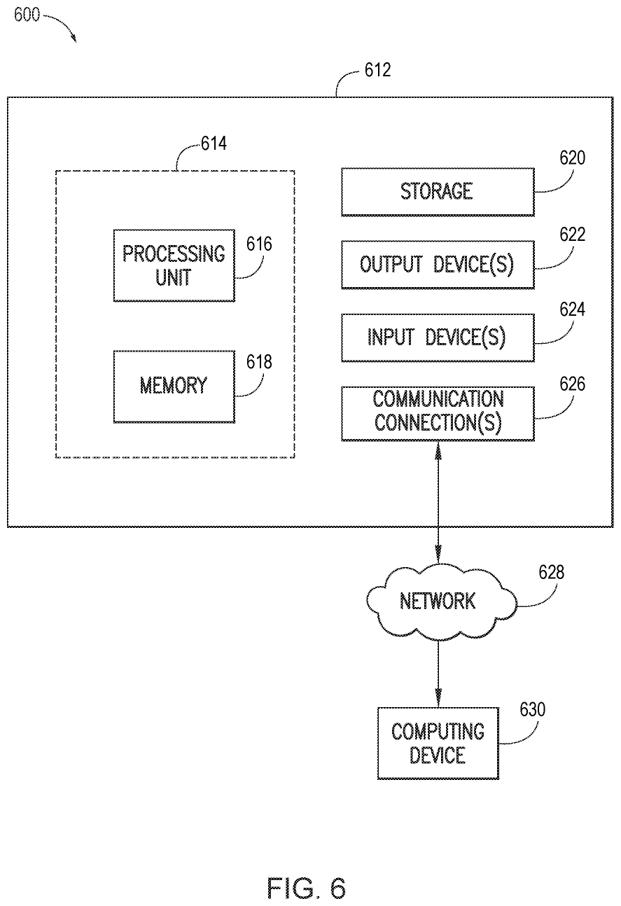

FIG. 6 and the following discussion provide a description of a suitable computing environment to implement aspects of one or more of the provisions set forth herein. The operating environment of FIG. 6 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 6 illustrates a system 600 including a computing device 612 configured to implement one aspect provided herein. In one configuration, the computing device 612 includes at least one processing unit 616 and memory 618. Depending on the exact configuration and type of computing device, memory 618 may be volatile, such as RAM, non-volatile, such as ROM, flash memory, etc., or a combination of the two. This configuration is illustrated in FIG. 6 by dashed line 614.

In other aspects, the computing device 612 includes additional features or functionality. For example, the computing device 612 may include additional storage such as removable storage or non-removable storage, including, but not limited to, magnetic storage, optical storage, etc. Such additional storage is illustrated in FIG. 6 by storage 620. In one aspect, computer readable instructions to implement one aspect provided herein are in storage 620. Storage 620 may store other computer readable instructions to implement an operating system, an application program, etc. Computer readable instructions may be loaded in memory 618 for execution by the at least one processing unit 616, for example.

The term “computer readable media” as used herein includes computer storage media. Computer storage media includes volatile and nonvolatile, removable, and non-removable media implemented in any method or technology for storage of information such as computer readable instructions or other data. Memory 618 and storage 620 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 612. Any such computer storage media is part of the computing device 612.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 612 includes input device(s) 624 such as keyboard, mouse, pen, voice input device, touch input device, infrared cameras, video input devices, or any other input device. Output device(s) 622 such as one or more displays, speakers, printers, or any other output device may be included with the computing device 612. Input device(s) 624 and output device(s) 622 may be connected to the computing device 612 via a wired connection, wireless connection, or any combination thereof. In one aspect, an input device or an output device from another computing device may be used as input device(s) 624 or output device(s) 622 for the computing device 612. The computing device 612 may include communication connection(s) 626 to facilitate communications with one or more other devices 630, such as through network 628, for example.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A system for dynamic causal graph prediction, comprising:
a memory storing one or more instructions;
a processor executing one or more of the instructions stored on the memory to perform:
generating a time varying dynamic causal graph of one or more participants within an operating environment including an ego-vehicle, one or more agents, and one or more potential obstacles;
generating an action prediction for each participant within the operating environment based on the dynamic causal graph; and
generating a control action for the ego-vehicle based on the action prediction for each participant within the operating environment.

2. The system for dynamic causal graph prediction of claim 1, wherein one or more nodes of the dynamic causal graph represent the ego-vehicle or one or more of the agents.

3. The system for dynamic causal graph prediction of claim 1, wherein one or more edges of the dynamic causal graph represent a causal relationship or a correlative relationship between two nodes of the dynamic causal graph.

4. The system for dynamic causal graph prediction of claim 2, wherein the causal relationship includes at least one of a leader-follower relationship, a trajectory-dependency relationship, or a collision relationship, and
the correlative relationship includes at least a negotiation relationship.

5. The system for dynamic causal graph prediction of claim 4, wherein the dynamic causal graph includes directed acyclic graph characteristics and cyclic graph characteristics.

6. The system for dynamic causal graph prediction of claim 5, wherein the directed acyclic graph characteristics are associated with the causal relationship in which the one or more participants influences another of the one or more participants.

7. The system for dynamic causal graph prediction of claim 5, wherein the cyclic graph characteristics are associated with the correlative relationship in which the one or more participants influence each other simultaneously.

8. The system for dynamic causal graph prediction of claim 7, wherein the cyclic graph characteristics are represented as a cycle in which the one or more edges of the dynamic causal graph representing the correlative relationship between the two nodes of the dynamic causal graph are a hypernode performing joint prediction.

9. The system for dynamic causal graph prediction of claim 8, wherein the joint prediction performed by the hypernode is mathematically represented as P{A,B,C}=P{B}×P{A,C|B}, capturing a probability of events A, B, and C occurring together within the dynamic causal graph.

10. The system for dynamic causal graph prediction of claim 9, further comprising:
refining the joint prediction with an iterative update equation mathematically represented as P{A,C|B}=P{A|C}×P{C|B}+P{C|A}×P{A|B}, wherein a conditional probability of events A and C given B is iteratively updated based on interdependencies within the dynamic causal graph.

11. The system for dynamic causal graph prediction of claim 1, wherein one or more of the agents is another vehicle, a bicycle, or a motorcycle.

12. The system for dynamic causal graph prediction of claim 1, wherein one or more of the potential obstacles is another vehicle, a bicycle, a motorcycle, a traffic sign, a pedestrian, an intersection, or a road feature.

13. The system for dynamic causal graph prediction of claim 1, wherein the action prediction for each participant is an intention prediction or a trajectory prediction.

14. The system for dynamic causal graph prediction of claim 1, wherein the control action is a warning to be provided by a vehicle system.

15. The system for dynamic causal graph prediction of claim 1, wherein the control action is a driving maneuver to be implemented by a vehicle system.

16. A computer-implemented method for dynamic causal graph prediction, comprising:
generating a time varying dynamic causal graph of one or more participants within an operating environment including an ego-vehicle, one or more agents, and one or more potential obstacles;
generating an action prediction for each participant within the operating environment based on the dynamic causal graph; and
generating a control action for the ego-vehicle based on the action prediction for each participant within the operating environment.

17. The computer-implemented method for dynamic causal graph prediction of claim 16, wherein
one or more edges of the dynamic causal graph represent a causal relationship or a correlative relationship between two nodes of the dynamic causal graph, and
the dynamic causal graph includes directed acyclic graph characteristics and cyclic graph characteristics.

18. The computer-implemented method for dynamic causal graph prediction of claim 17, wherein
the causal relationship includes at least one of a leader-follower relationship, a trajectory-dependency relationship, or a collision relationship,
the correlative relationship includes at least a negotiation relationship,
the directed acyclic graph characteristics are associated with the causal relationship in which the one or more participants influences another of the one or more participants, and
the cyclic graph characteristics are associated with the correlative relationship in which the one or more participants influence each other simultaneously.

19. The computer-implemented method for dynamic causal graph prediction of claim 18, wherein
the cyclic graph characteristics are represented as a cycle in which the one or more edges of the dynamic causal graph representing the correlative relationship between the two nodes of the dynamic causal graph are a hypernode performing joint prediction,
the joint prediction performed by the hypernode is mathematically represented as P{A,B,C}=P{B}×P{A,C|B}, capturing a probability of events A, B, and C occurring together within the dynamic causal graph, and
the method further includes:
refining the joint prediction with an iterative update equation mathematically represented as P{A,C|B}=P{A|C}×P{C|B}+P{C|A}×P{A|B}, wherein a conditional probability of events A and C given B is iteratively updated based on interdependencies within the dynamic causal graph.

20. A vehicle, comprising:
a vehicle sensor system;
a vehicle actuator system; and
a vehicle electronic control unit in communication with the vehicle sensor system and the vehicle actuator system, the electronic control unit, in conjunction with a memory storing one or more instructions, being programmed to execute the one or more instructions to:
generate a time varying dynamic causal graph of one or more participants within an operating environment including the vehicle, one or more agents, and one or more potential obstacles based on input from the vehicle sensing system;
generate an action prediction for each participant within the operating environment based on the dynamic causal graph; and
generate a control action for the vehicle based on the action prediction for each participant within the operating environment, wherein
the vehicle actuator system controls the vehicle to perform the control action.
